(19) United States
(12) Patent Application Publication
(10) Pub. No.: US 2026/0346469 A1
(43) Pub. Date: Nov. 5, 2026

(54) MECHANICAL HAND AND CLEANING APPARATUS

(71) Applicant: Dreame Innovation Technology (Suzhou) Co., Ltd., Suzhou (CN)

(72) Inventors: Hongzeng HU, Suzhou (CN); Jiahao LI, Suzhou (CN); Zhenwei ZHAN, Suzhou (CN)

(21) Appl. No.: 19/656,582

(22) Filed: Apr. 23, 2026

Related U.S. Application Data
(63) Continuation of application No. PCT/CN2026/070677, filed on Jan. 5, 2026.

(30) Foreign Application Priority Data
Apr. 30, 2025 (CN) 202520851637.5

(51) Int. Cl. B25J 11/00; A47L 9/00; B25J 5/00; B25J 15/00

(52) U.S. Cl. CPC B25J 11/0085; A47L 9/009; B25J 5/00; B25J 15/0028; A47L 2201/00

(57) ABSTRACT

The present application relates to a mechanical hand and a cleaning apparatus. The mechanical hand includes: a basic folding mechanism, including a mounting base and a basic rotating assembly, where the mounting base is configured to be arranged on the cleaning apparatus, the basic rotating assembly is rotatable about a first basic axis parallel to a horizontal plane so as to be rotatably connected to the mounting base; an operating folding mechanism, including a clamping jaw, a first operating arm and a second operating arm, where the first operating arm is located between the clamping jaw and the second operating arm; and an intermediate folding mechanism, including an intermediate arm, where two ends of the intermediate arm are rotatably connected to the second operating arm and the basic rotating assembly respectively.

### CROSS-REFERENCE TO RELATED APPLICATIONS

This application is a continuation of International Application No. PCT/CN2026/070677, filed on Jan. 5, 2026, which claims priority to Chinese Patent Application No. 202520851637.5, entitled "Mechanical Hand and Cleaning Apparatus", filed with the China National Intellectual Property Administration on Apr. 30, 2025. Both of the aforementioned applications are hereby incorporated by reference in their entireties.

### TECHNICAL FIELD

The present application relates to the field of cleaning apparatus technology and, in particular, to a mechanical hand and a cleaning apparatus.

### BACKGROUND

A cleaning apparatus is an important smart home appliance device. With the rapid development of artificial intelligence, the application of cleaning apparatuses is becoming increasingly widespread. Cleaning apparatuses can automatically complete cleaning work on the ground by means of sweeping or vacuuming using artificial intelligence. However, for traditional cleaning apparatuses, small debris on the ground usually cannot be removed, and the ground in narrow spaces cannot be cleaned, which will affect the applicability of the cleaning apparatus to various working conditions.

### SUMMARY

One technical problem solved by the present application is how to improve the applicability of a cleaning apparatus to various working conditions.

A mechanical hand is provided, which is applied to a cleaning apparatus, and the mechanical hand includes:
a basic folding mechanism, including a mounting base and a basic rotating assembly, where the mounting base is configured to be arranged on the cleaning apparatus, the basic rotating assembly is rotatable about a first basic axis parallel to a horizontal plane so as to be rotatably connected to the mounting base;
an operating folding mechanism, including a clamping jaw, a first operating arm, and a second operating arm, where the first operating arm is located between the clamping jaw and the second operating arm, one end of the first operating arm is rotatable about a first operating axis so as to be rotatably connected to the clamping jaw, the other end of the first operating arm is rotatable about a second operating axis perpendicular to the first operating axis so as to be rotatably connected to the second operating arm; and
an intermediate folding mechanism, including an intermediate arm, where both ends of the intermediate arm are rotatably connected to the second operating arm and the basic rotating assembly respectively, the intermediate arm is capable of being superposed between the basic folding mechanism and the operating folding mechanism during storage so that the mechanical hand is in a folded state.

In an embodiment, the basic rotating assembly includes a first basic arm and a second basic arm, one end of the first basic arm is rotatable about the first basic axis so as to be rotatably connected to the mounting base, the other end of the first basic arm is rotatable about a second basic axis perpendicular to the first basic axis so as to be rotatably connected to one end of the second basic arm, and the other end of the second basic arm is rotatably connected to the intermediate folding mechanism.

In an embodiment, the lengths of the mounting base, the basic rotating assembly, the clamping jaw, the first operating arm, and the second operating arm are all less than a length of the intermediate arm.

In an embodiment, the basic folding mechanism further includes a first basic joint, the first basic joint is arranged on the mounting base, an output shaft of the first basic joint is rotatable about the first basic axis, and the first basic arm is connected to the output shaft of the first basic joint.

In an embodiment, the mounting base includes a first base body and a second base body, the first base body is configured to be connected to the cleaning apparatus, the second base body protrudes from an end portion of the first base body and the second base body together with the first base body encloses a mounting recessed groove ; the first basic arm includes a first basic portion and a second basic portion, the first basic portion is connected to the second basic arm, the second basic portion protrudes from an end portion of the first basic portion and the second basic portion together with the first basic portion encloses a basic recessed groove, the second base body engages with the basic recessed groove, and the second basic portion engages with the mounting recessed groove.

In an embodiment, the basic folding mechanism further includes a second basic joint, the second basic joint is arranged on the first basic arm, an output shaft of the second basic joint is rotatable about the second basic axis, and the second basic arm is connected to the output shaft of the second basic joint.

In an embodiment, the intermediate folding mechanism further comprises a first collar and a first intermediate joint, the first intermediate joint is arranged on the basic folding mechanism, an output shaft of the first intermediate joint is rotatable about a first intermediate axis perpendicular to the second operating axis, the basic folding mechanism is provided with a first slit, the first collar is connected to one end portion of the intermediate arm, the first collar is rotatably arranged in the first slit and is connected to the output shaft of the first intermediate joint.

In an embodiment, the intermediate folding mechanism further includes a second collar and a second intermediate joint, the second intermediate joint is arranged on the second operating arm, an output shaft of the second intermediate joint is rotatable about a second intermediate axis perpendicular to the second operating axis, the second operating arm is provided with a second slit, the second collar is connected to the other end portion of the intermediate arm, the second collar is rotatably arranged in the second slit and is connected to the output shaft of the second intermediate joint.

In an embodiment, the mechanical hand further includes at least one of the following configurations:
the operating folding mechanism further includes a first operating joint, the first operating joint is arranged on the first operating arm, an output shaft of the first operating joint is rotatable about the first operating axis, and the clamping jaw is connected to the output shaft of the first operating joint;
the operating folding mechanism further includes a second operating joint, the second operating joint is arranged on the second operating arm, an output shaft of the second operating joint is rotatable about the second operating axis, and the first operating arm is connected to the output shaft of the second operating joint.

A cleaning apparatus includes a host and the mechanical hand according to any one of the above, the host is provided with a mounting groove, the mounting base is connected to the host, and the basic folding mechanism, the intermediate folding mechanism, and the operating folding mechanism which are superposed to one another are capable of being at least partially accommodated in the mounting groove.

A technical effect of an embodiment of the present application is: given that the mechanical hand is configured to be arranged on the host of the cleaning apparatus, in the case where on the ground there is small debris with small weight and volume, the mechanical hand can start moving, causing the clamping jaw to clamp the small debris for discarding to a designated location, thereby achieving effective removal of the small debris. Moreover, for special positions such as under a sofa, the edge of a table, and a corner, the clamping jaw can clamp a cleaning member such as a brush or a cloth to effectively clean the special position, thereby improving the applicability of the cleaning apparatus to different working conditions.

### BRIEF DESCRIPTION OF DRAWINGS

FIG. 1 is a schematic structural diagram of a cleaning apparatus provided by an embodiment from a top view.

FIG. 2 is a schematic perspective structural diagram of a mechanical hand in the cleaning apparatus shown in FIG. 1 when unfolded.

FIG. 3 is a schematic perspective structural diagram of the mechanical hand shown in FIG. 2 when folded.

FIG. 4 is a schematic plan structural diagram of the mechanical hand shown in FIG. 2 when folded.

FIG. 5 is a first exemplary exploded structural diagram of the mechanical hand shown in FIG. 2 when unfolded.

FIG. 6 is a second exemplary exploded structural diagram of the mechanical hand shown in FIG. 2 when unfolded.

FIG. 7 is a schematic perspective sectional structural diagram of the mechanical hand shown in FIG. 2 when unfolded.

FIG. 8 is a schematic plan structural diagram of the mechanical hand shown in FIG. 2 when unfolded.

Reference numerals: cleaning apparatus 10, host 11, mounting groove 13, mechanical hand 12, basic folding mechanism 100, mounting base 110, first base body 111, second base body 112, mounting recessed groove 113, basic rotating assembly 120, first basic arm 121, first basic portion 1211, second basic portion 1212, basic recessed groove 1213, second basic arm 122, first slit 1221, first basic joint 130, second basic joint 140, first basic axis 151, second basic axis 152, intermediate folding mechanism 200, intermediate arm 210, first collar 221, second collar 222, first intermediate joint 231, second intermediate joint 232, first intermediate axis 251, second intermediate axis 252, operating folding mechanism 300, first operating arm 310, second operating arm 320, second slit 321, clamping jaw 330, first operating joint 341, second operating joint 342, first operating axis 351, second operating axis 352.

### DESCRIPTION OF EMBODIMENTS

In order to make the above objectives, features, and advantages of the present application more clearly understood, the specific embodiments of the present application are described in detail below with reference to the accompanying drawings. In the following description, many specific details are set forth to facilitate a full understanding of the present application. However, the present application can be implemented in many other ways different from those described herein, and those skilled in the art can make similar improvements without departing from the connotation of the present application, so the present application is not limited by the specific embodiments disclosed below.

In the description of the present application, it should be understood that if terms such as "center", "longitudinal", "transverse", "length", "width", "thickness", "upper", "lower", "front", "rear", "left", "right", "vertical", "horizontal", "top", "bottom", "inner", "outer", "clockwise", "counterclockwise", "axial", "radial", "circumferential" appear, orientations or positional relationships indicated by these terms are orientations or positional relationships based on the orientations or positional relationships shown in the drawings, which are only for the convenience of describing the present application and simplifying the description, and do not indicate or imply that the device or element referred to must have a specific orientation, be constructed and operated in a specific orientation, and therefore cannot be understood as limitations on the present application.

Furthermore, if terms such as "first" and "second" appear, these terms are used for descriptive purposes only and cannot be understood as indicating or implying relative importance or implicitly indicating the number of technical features indicated. Thus, features defined with "first" and "second" may explicitly or implicitly include at least one such feature. In the description of the present application, if the term "plurality" appears, the meaning of "plurality" is at least two, such as two, three, etc., unless otherwise explicitly and specifically defined.

In the present application, unless otherwise explicitly specified and defined, if terms such as "install", "connect", "link", "fix" appear, these terms should be understood broadly. For example, it may be a fixed connection, or a detachable connection, or integrated into one; it may be a mechanical connection, or an electrical connection; it may be a direct connection, or an indirect connection through an intermediate medium, or it may be the internal communication between two elements or the interaction relationship between two elements, unless otherwise explicitly defined. For those of ordinary skill in the art, the specific meanings of the above terms in the present application can be understood according to specific circumstances.

In the present application, unless otherwise explicitly specified and defined, if descriptions such as a first feature being "on" or "under" a second feature appear, the meaning may be that the first feature and the second feature are in direct contact, or the first feature and the second feature are in indirect contact through an intermediate medium. Moreover, the first feature being "on", "above", and "over" the second feature may mean that the first feature is directly above or obliquely above the second feature, or merely indicates that the horizontal height of the first feature is higher than that of the second feature. The first feature being "under", "below", and "beneath" the second feature may mean that the first feature is directly below or obliquely below the second feature, or merely indicates that the horizontal height of the first feature is less than that of the second feature.

It should be noted that if an element is referred to as being "fixed to" or "arranged on" another element, it can be directly on the other element or there may be an intervening element. If one element is considered to be "connected" to another element, it can be directly connected to the other element or there may be intervening elements at the same time. If present, the terms "vertical", "horizontal", "upper", "lower", "left", "right" and similar expressions used in the present application are for illustrative purposes only and do not represent the only implementation.

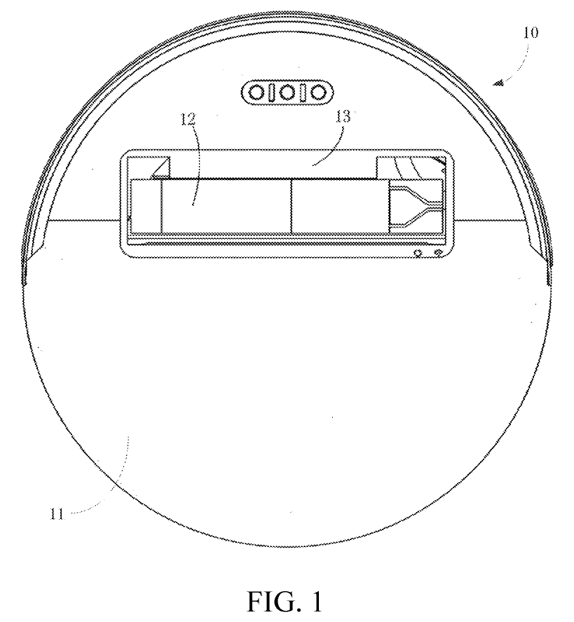

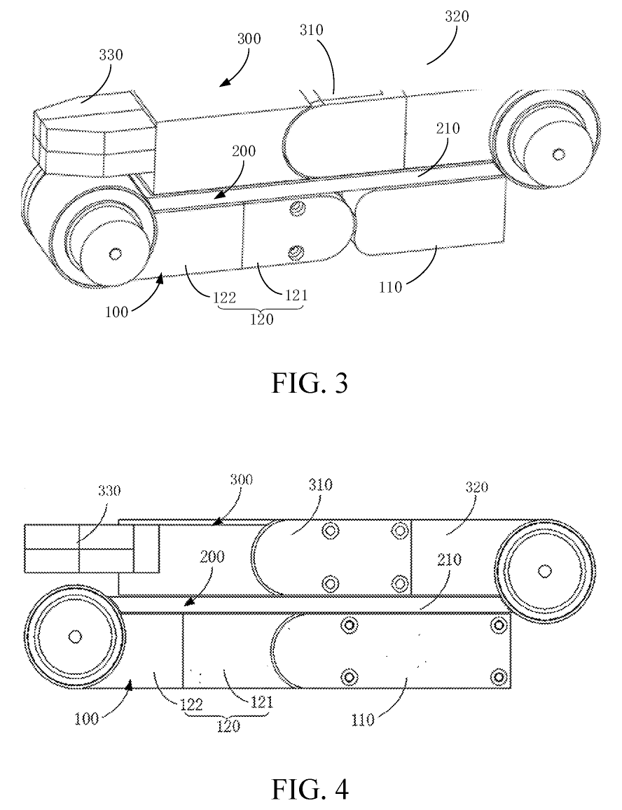

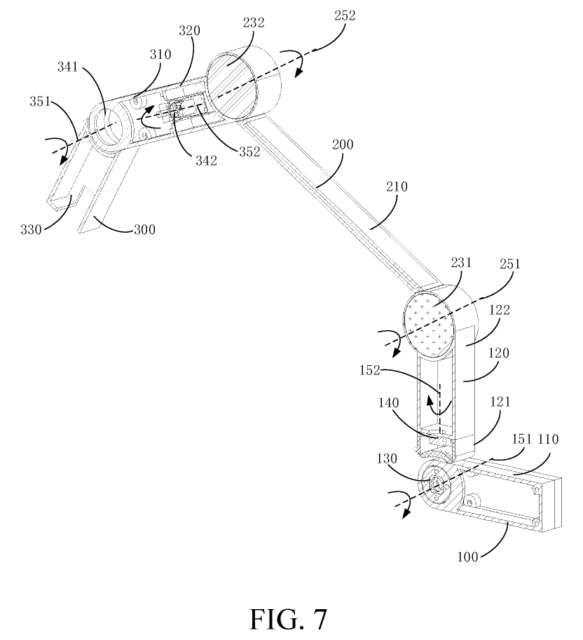

Referring to FIGS. 1, 2, 3 and 4, a mechanical hand 12 provided by an embodiment of the present application is applied to a cleaning apparatus 10, and the cleaning apparatus 10 can be a floor sweeping robot or the like. The mechanical hand 12 includes a basic folding mechanism 100, an intermediate folding mechanism 200, and an operating folding mechanism 300. The basic folding mechanism 100 includes a mounting base 110 and a basic rotating assembly 120, the mounting base 110 is fixed on a host 11 of the cleaning apparatus 10, the basic rotating assembly 120 is rotatable about a first basic axis 151 (as shown in FIG. 7) parallel to a horizontal plane so as to be rotatably connected to the mounting base 110, that is, the basic rotating assembly 120 and the mounting base 110 are rotatable relative to each other about the first basic axis 151. The operating folding mechanism 300 includes a first operating arm 310, a second operating arm 320, and a clamping jaw 330, the first operating arm 310 is located between the clamping jaw 330 and the second operating arm 320, one end of the first operating arm 310 is rotatable about a first operating axis 351 so as to be rotatably connected to the clamping jaw 330, that is, the first operating arm 310 and the clamping jaw 330 are rotatable relative to each other about the first operating axis 351. The other end of the first operating arm 310 is rotatable about a second operating axis 352 so as to be rotatably connected to the second operating arm 320, the second operating axis 352 is perpendicular to the first operating axis 351, that is, the first operating arm 310 and the second operating arm 320 are rotatable relative to each other about the second operating axis 352. The intermediate folding mechanism 200 includes an intermediate arm 210, both ends of the intermediate arm 210 are respectively rotatable about axes perpendicular to the second operating axis 352 so as to be rotatably connected to the second operating arm 320 and the basic rotating assembly 120, that is, both the second operating arm 320 and the basic rotating assembly 120 are rotatable relative to the intermediate arm 210 about axes perpendicular to the second operating axis 352. This allows the intermediate arm 210 to be superposed between the basic folding mechanism 100 and the operating folding mechanism 300 during storage, thereby achieving folding of the entire mechanical hand 12, at which time the mechanical hand 12 is in a folded state.

Thus, the entire mechanical hand 12 has at least five rotational degrees of freedom, enabling the clamping jaw 330 to accurately move to a specified position in three-dimensional space to perform tasks, ultimately improving the motion accuracy of the mechanical hand 12. When the mechanical hand 12 needs to perform a task, the mechanical hand 12 can be unfolded, and when the mechanical hand 12 does not need to perform a task, the mechanical hand 12 can be folded, thereby reducing the space occupied by the mechanical hand 12 and avoiding collisions and interference between the mechanical hand 12 and other objects during the operation of the cleaning apparatus 10.

If a mode where a mechanical hand is not arranged on the host of the cleaning apparatus is adopted, in the case where on the ground there is small debris with small weight and volume, the cleaning apparatus can only adopt an obstacle avoidance method to bypass the small debris, causing the cleaning apparatus to be unable to remove the small debris. Moreover, for special positions such as under a sofa, the edge of a table, and a corner, the cleaning apparatus cannot clean the special position, which will affect the applicability of the cleaning apparatus to different working conditions.

For the mechanical hand 12 in the above embodiment, the mechanical hand 12 is arranged on the host 11 of the cleaning apparatus 10. In the case where on the ground there is small debris with small weight and volume, the mechanical hand 12 can start moving, causing the clamping jaw 330 to clamp the small debris for discarding to a specified location, thereby achieving effective removal of the small debris. Moreover, for special positions such as under a sofa, the edge of a table, and a corner, the clamping jaw 330 can clamp a cleaning member such as a brush or a cloth to effectively clean the special position, thereby improving the applicability of the cleaning apparatus 10 to different working conditions.

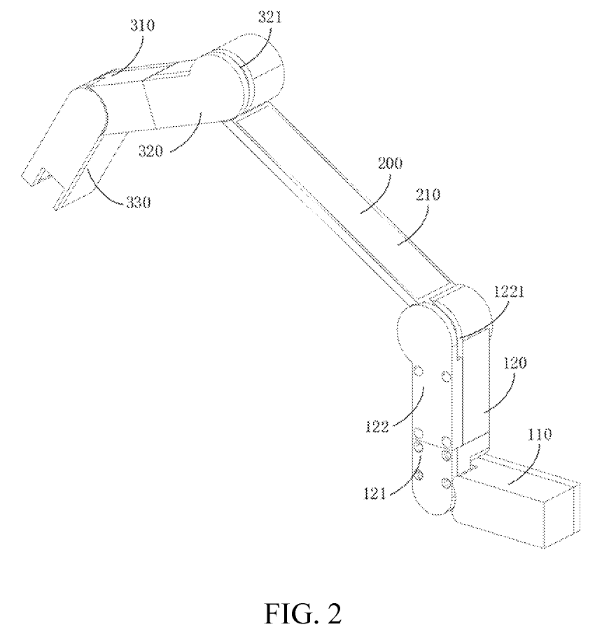

Referring to FIGS. 2, 5 and 7, in some embodiments, the basic rotating assembly 120 includes a first basic arm 121 and a second basic arm 122, one end of the first basic arm 121 is rotatable about the first basic axis 151 so as to be rotatably connected to the mounting base 110, the other end of the first basic arm 121 is rotatable about a second basic axis 152 so as to be rotatably connected to one end of the second basic arm 122, the first basic axis 151 and the second basic axis 152 are perpendicular to each other, and the other end of the second basic arm 122 is rotatable about a first intermediate axis 251 so as to be rotatably connected to the intermediate folding mechanism 200. By making the first basic arm 121 and the second basic arm 122 rotatably connected, a new degree of freedom can be added to the mechanical hand 12, so that the mechanical hand 12 has six rotational degrees of freedom, thereby further improving the motion accuracy of the clamping jaw 330.

Referring to FIGS. 2, 5 and 7, in some embodiments, the basic folding mechanism 100 further includes a first basic joint 130, the first basic joint 130 is arranged on the mounting base 110, and the first basic joint 130 may include a gearbox or a motor or the like. An output shaft of the first basic joint 130 is rotatable about the first basic axis 151, and the first basic arm 121 is fixedly connected to the output shaft of the first basic joint 130, thereby realizing rotation of the first basic arm 121 relative to the mounting base 110 about the first basic axis 151. In other embodiments, the first basic joint 130 may also be arranged on the first basic arm 121, as long as the first basic arm 121 is rotatable relative to the mounting base 110.

Referring to FIGS. 2, 5 and 7, in some embodiments, the basic folding mechanism 100 further includes a second basic joint 140, the second basic joint 140 is arranged on the first basic arm 121, and the second basic joint 140 can be a motor or the like. An output shaft of the second basic joint 140 is rotatable about a second basic axis 152, the second basic arm 122 is connected to the output shaft of the second basic joint 140, thereby rotation of the second basic arm 122 about the second basic axis 152 relative to the first basic arm 121 is realized. In other embodiments, the second basic joint 140 can also be arranged on the first basic arm 121, as long as relative rotation between the first basic arm 121 and the second basic arm 122 can be realized.

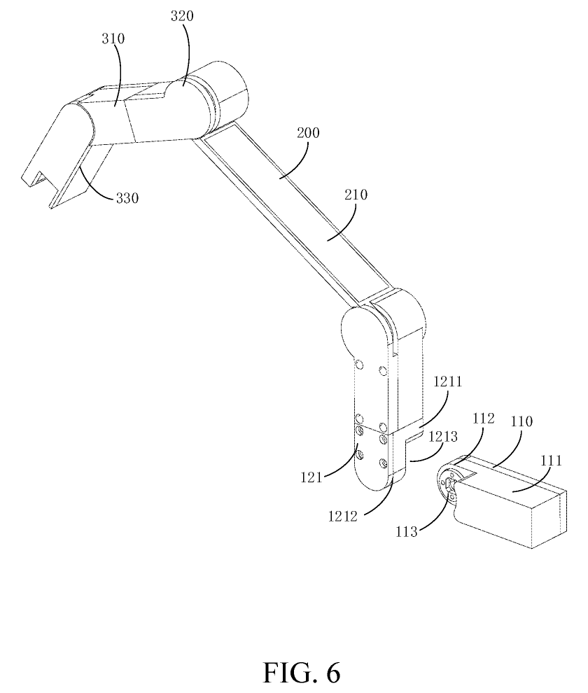

Referring to FIG. 6, in some embodiments, the mounting base 110 includes a first base body 111 and a second base body 112, the first base body 111 is configured to be connected to the host 11, the second base body 112 protrudes from an end portion of the first base body 111, and the first base body 111 and the second base body 112 enclose a mounting recessed groove 113. The first basic arm 121 includes a first basic portion 1211 and a second basic portion 1212, the second basic portion 1212 protrudes from an end portion of the first basic portion 1211, and the second basic portion 1212 and the first basic portion 1211 enclose a basic recessed groove 1213. The second base body 112 engages with the basic recessed groove 1213, and the second basic portion 1212 engages with the mounting recessed groove 113. Thus, the second base body 112 and the second basic portion 1212 can abut against each other along an extending direction of the first basic axis 151, the second base body 112 and the first basic portion 1211 can abut against each other along an extending direction of the second basic axis 152, and the second basic portion 1212 and the first base body 111 can abut against each other along a direction simultaneously perpendicular to extending directions of both the first basic axis 151 and the second basic axis 152, thereby rotation of the first basic joint 130 relative to the mounting base 110 is well limited, vibration of the first basic joint 130 during rotation is avoided, and rotation accuracy of the first basic joint 130 relative to the mounting base 110 is improved.

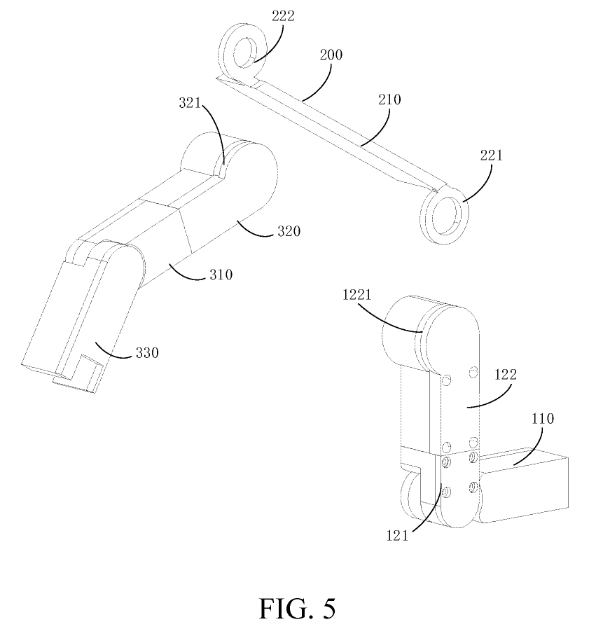

Referring to FIGS. 5, 6 and 7, in some embodiments, the intermediate folding mechanism 200 further includes a first collar 221 and a first intermediate joint 231, the first collar 221 is connected to one end portion of the intermediate arm 210. The first intermediate joint 231 is arranged on the second basic arm 122 of the basic folding mechanism 100, the first intermediate joint 231 can be a motor or the like, an output shaft of the first intermediate joint 231 is rotatable about a first intermediate axis 251, the first intermediate axis 251 is perpendicular to the second operating axis 352, the second basic arm 122 is provided with a first slit 1221, the output shaft of the first intermediate joint 231 passes through the first slit 1221, the first collar 221 is accommodated in the first slit 1221, and the first collar 221 is fixedly sleeved on the output shaft of the first intermediate joint 231. When the output shaft of the first intermediate joint 231 rotates, the first collar 221 and the intermediate arm 210 are driven to rotate relative to the second basic arm 122. By providing the first slit 1221, rotation of the first collar 221 along the extending direction of the first intermediate axis 251 can be limited, thereby vibration of the intermediate arm 210 during rotation is reduced, and rotation accuracy of the intermediate arm 210 is improved.

Referring to FIGS. 5, 6 and 7 in some embodiments, the intermediate folding mechanism 200 further includes a second collar 222 and a second intermediate joint 232, the second collar 222 is connected to the other end portion of the intermediate arm 210. The second intermediate joint 232 is arranged on the second operating arm 320, the second intermediate joint 232 can be a motor or the like, an output shaft of the second intermediate joint 232 is rotatable about a second intermediate axis 252, the second intermediate axis 252 is parallel to the first intermediate axis 251, so that the second intermediate axis 252 is perpendicular to the second operating axis 352, the second operating arm 320 is provided with a second slit 321, the output shaft of the second intermediate joint 232 passes through the second slit 321, the second collar 222 is accommodated in the second slit 321, and the second collar 222 is fixedly sleeved on the output shaft of the second intermediate joint 232. When the output shaft of the second intermediate joint 232 rotates, the second collar 222 and the intermediate arm 210 are driven to rotate relative to the second operating arm 320. By providing the second slit 321, rotation of the second collar 222 along the extending direction of the second intermediate axis 252 can be limited, thereby vibration of the intermediate arm 210 during rotation is reduced, and rotation accuracy of the intermediate arm 210 is improved.

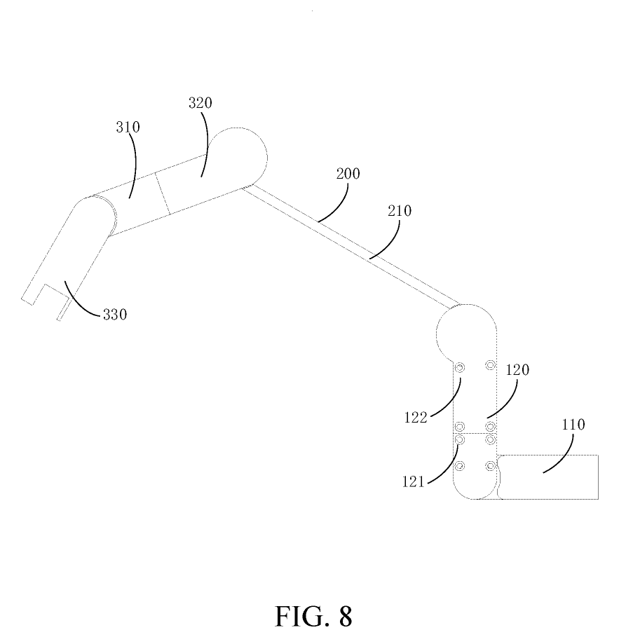

Referring to FIGS. 6, 7, and 8 in some embodiments, the operating folding mechanism 300 further includes a first operating joint 341, the first operating joint 341 can be a motor or the like, the first operating joint 341 is arranged on the first operating arm 310, an output shaft of the first operating joint 341 is rotatable about a first operating axis 351, the clamping jaw 330 is connected to the output shaft of the first operating joint 341, thereby relative rotation of the clamping jaw 330 and the first operating arm 310 about the first operating axis 351 is realized. In other embodiments, the first operating joint 341 can also be arranged on the clamping jaw 330.

Referring to FIGS. 6, 7 and 8 , in some embodiments, the operating folding mechanism 300 further includes a second operating joint 342, the second operating joint 342 can be a gearbox or the like. An output shaft of the second operating joint 342 is rotatable about the second operating axis 352, the first operating arm 310 is connected to the output shaft of the second operating joint 342, thereby relative rotation of the first operating arm 310 and the second operating arm 320 about the second operating axis 352 is realized. In other embodiments, the second operating joint 342 can also be arranged on the first operating arm 310, and the second operating joint 342 can be a motor.

Referring to FIGS. 2, 3 and 4 in some embodiments, lengths of the mounting base 110, the basic rotating assembly 120, the clamping jaw 330, the first operating arm 310 and the second operating arm 320 are all less than a length of the intermediate arm 210. Thus, interference can be eliminated, so that the intermediate arm 210 can be successfully superposed between the basic folding mechanism 100 and the operating folding mechanism 300, and finally folding of the entire mechanical hand 12 is realized.

Referring to FIG. 1, the present application further provides a cleaning apparatus 10, the cleaning apparatus 10 includes a host 11 and the mechanical hand 12, the host 11 is provided with a mounting groove 13, the mounting base 110 is connected to the host 11, the mounting base 110 is capable of being at least partially accommodated in the mounting groove 13, the basic folding mechanism 100, the intermediate folding mechanism 200 and the operating folding mechanism 300 which are superposed to one another are capable of being at least partially accommodated in the mounting groove 13, so that the folded mechanical hand 12 is capable of being at least partially accommodated in the mounting groove 13, thereby occupied space of the entire cleaning apparatus 10 is reduced, and convenience of transportation and storage of the cleaning apparatus 10 is improved.

When the mechanical hand 12 is in the folded state, the first basic axis 151, the first intermediate axis 251, the second intermediate axis 252 and the first operating axis 351 are parallel to each other, and all four are perpendicular to the paper surface. Both the second basic axis 152 and the second operating axis 352 are perpendicular to the aforementioned four axes, so that the second basic axis 152 and the second operating axis 352 are parallel to the paper surface.

The technical features of the above-described embodiments can be arbitrarily combined. For the sake of brevity of description, not all possible combinations of the technical features in the above embodiments are described. However, as long as there is no contradiction in the combination of these technical features, they should be considered as being within the scope described in this specification.

The above-described embodiments merely express several implementations of the present application, and the description thereof is relatively specific and detailed, but should not be construed as limiting the scope of the patent application. It should be pointed out that, for those of ordinary skill in the art, several modifications and improvements can be made without departing from the concept of the present application, and these all fall within the protection scope of the present application. Therefore, the protection scope of the present patent application shall be subject to the appended claims.

What is claimed is:

1. A mechanical hand, applied to a cleaning apparatus, wherein the mechanical hand comprises:
a basic folding mechanism, comprising a mounting base and a basic rotating assembly, wherein the mounting base is configured to be arranged on the cleaning apparatus, and the basic rotating assembly is rotatable about a first basic axis parallel to a horizontal plane so as to be rotatably connected to the mounting base;
an operating folding mechanism, comprising a clamping jaw, a first operating arm and a second operating arm, wherein the first operating arm is located between the clamping jaw and the second operating arm, one end of the first operating arm is rotatable about a first operating axis so as to be rotatably connected to the clamping jaw, and the other end of the first operating arm is rotatable about a second operating axis perpendicular to the first operating axis so as to be rotatably connected to the second operating arm; and
an intermediate folding mechanism, comprising an intermediate arm, wherein two ends of the intermediate arm are rotatably connected to the second operating arm and the basic rotating assembly respectively, and the intermediate arm is capable of being superposed between the basic folding mechanism and the operating folding mechanism during storage so that the mechanical hand is in a folded state.

2. The mechanical hand according to claim 1, wherein the basic rotating assembly comprises a first basic arm and a second basic arm, one end of the first basic arm is rotatable about the first basic axis so as to be rotatably connected to the mounting base, the other end of the first basic arm is rotatable about a second basic axis perpendicular to the first basic axis so as to be rotatably connected to one end of the second basic arm, and the other end of the second basic arm is rotatably connected to the intermediate folding mechanism.

3. The mechanical hand according to claim 2, wherein lengths of the mounting base, the basic rotating assembly, the clamping jaw, the first operating arm and the second operating arm are all less than a length of the intermediate arm.

4. The mechanical hand according to claim 2, wherein the basic folding mechanism further comprises a first basic joint, the first basic joint is arranged on the mounting base, an output shaft of the first basic joint is rotatable about the first basic axis, and the first basic arm is connected to the output shaft of the first basic joint.

5. The mechanical hand according to claim 2, wherein the mounting base comprises a first base body and a second base body, the first base body is configured to be connected to the cleaning apparatus, the second base body protrudes from an end portion of the first base body and the second base body together with the first base body encloses a mounting recessed groove; the first basic arm comprises a first basic portion and a second basic portion, the first basic portion is connected to the second basic arm, the second basic portion protrudes from an end portion of the first basic portion and the second basic portion together with the first basic portion encloses a basic recessed groove, the second base body engages with the basic recessed groove, and the second basic portion engages with the mounting recessed groove.

6. The mechanical hand according to claim 2, wherein the basic folding mechanism further comprises a second basic joint, the second basic joint is arranged on the first basic arm, an output shaft of the second basic joint is rotatable about the second basic axis, and the second basic arm is connected to the output shaft of the second basic joint.

7. The mechanical hand according to claim 1, wherein the intermediate folding mechanism further comprises a first collar and a first intermediate joint, the first intermediate joint is arranged on the basic folding mechanism, an output shaft of the first intermediate joint is rotatable about a first intermediate axis perpendicular to the second operating axis, the basic folding mechanism is provided with a first slit, the first collar is connected to one end portion of the intermediate arm, and the first collar is rotatably arranged in the first slit and is connected to the output shaft of the first intermediate joint.

8. The mechanical hand according to claim 1, wherein the intermediate folding mechanism further comprises a second collar and a second intermediate joint, the second intermediate joint is arranged on the second operating arm, an output shaft of the second intermediate joint is rotatable about a second intermediate axis perpendicular to the second operating axis, the second operating arm is provided with a second slit, the second collar is connected to the other end portion of the intermediate arm, and the second collar is rotatably arranged in the second slit and is connected to the output shaft of the second intermediate joint.

9. The mechanical hand according to claim 1, wherein the operating folding mechanism further comprises a first operating joint, wherein the first operating joint is arranged on the first operating arm, an output shaft of the first operating joint is rotatable about the first operating axis, and the clamping jaw is connected to the output shaft of the first operating joint.

10. The mechanical hand according to claim 1, wherein the operating folding mechanism further comprises a second operating joint, wherein the second operating joint is arranged on the second operating arm, an output shaft of the second operating joint is rotatable about the second operating axis, and the first operating arm is connected to the output shaft of the second operating joint.

11. A cleaning apparatus, comprising a host and the mechanical hand according to claim 1, wherein the host is provided with a mounting groove, the mounting base is connected to the host, and the basic folding mechanism, the intermediate folding mechanism and the operating folding mechanism which are superposed to one another are capable of being at least partially accommodated in the mounting groove.

12. The cleaning apparatus according to claim 11, wherein the basic rotating assembly comprises a first basic arm and a second basic arm, one end of the first basic arm is rotatable about the first basic axis so as to be rotatably connected to the mounting base, the other end of the first basic arm is rotatable about a second basic axis perpendicular to the first basic axis so as to be rotatably connected to one end of the second basic arm, and the other end of the second basic arm is rotatably connected to the intermediate folding mechanism.

13. The cleaning apparatus according to claim 12, wherein lengths of the mounting base, the basic rotating assembly, the clamping jaw, the first operating arm and the second operating arm are all less than a length of the intermediate arm.

14. The cleaning apparatus according to claim 12, wherein the basic folding mechanism further comprises a first basic joint, the first basic joint is arranged on the mounting base, an output shaft of the first basic joint is rotatable about the first basic axis, and the first basic arm is connected to the output shaft of the first basic joint.

15. The cleaning apparatus according to claim 12, wherein the mounting base comprises a first base body and a second base body, the first base body is configured to be connected to the cleaning apparatus, the second base body protrudes from an end portion of the first base body and the second base body together with the first base body encloses a mounting recessed groove; the first basic arm comprises a first basic portion and a second basic portion, the first basic portion is connected to the second basic arm, the second basic portion protrudes from an end portion of the first basic portion and the second basic portion together with the first basic portion encloses a basic recessed groove, the second base body engages with the basic recessed groove, and the second basic portion engages with the mounting recessed groove.

16. The cleaning apparatus according to claim 12, wherein the basic folding mechanism further comprises a second basic joint, the second basic joint is arranged on the first basic arm, an output shaft of the second basic joint is rotatable about the second basic axis, and the second basic arm is connected to the output shaft of the second basic joint.

17. The cleaning apparatus according to claim 11, wherein the intermediate folding mechanism further comprises a first collar and a first intermediate joint, the first intermediate joint is arranged on the basic folding mechanism, an output shaft of the first intermediate joint is rotatable about a first intermediate axis perpendicular to the second operating axis, the basic folding mechanism is provided with a first slit, the first collar is connected to one end portion of the intermediate arm, and the first collar is rotatably arranged in the first slit and is connected to the output shaft of the first intermediate joint.

18. The cleaning apparatus according to claim 11, wherein the intermediate folding mechanism further comprises a second collar and a second intermediate joint, the second intermediate joint is arranged on the second operating arm, an output shaft of the second intermediate joint is rotatable about a second intermediate axis perpendicular to the second operating axis, the second operating arm is provided with a second slit, the second collar is connected to the other end portion of the intermediate arm, and the second collar is rotatably arranged in the second slit and is connected to the output shaft of the second intermediate joint.

19. The cleaning apparatus according to claim 11, wherein the operating folding mechanism further comprises a first operating joint, wherein the first operating joint is arranged on the first operating arm, an output shaft of the first operating joint is rotatable about the first operating axis, and the clamping jaw is connected to the output shaft of the first operating joint.

20. The cleaning apparatus according to claim 11, wherein the operating folding mechanism further comprises a second operating joint, wherein the second operating joint is arranged on the second operating arm, an output shaft of the second operating joint is rotatable about the second operating axis, and the first operating arm is connected to the output shaft of the second operating joint.
